(19) United States
(12) Patent Application Publication
(10) Pub. No.: US 2026/0365497 A1
(43) Pub. Date: Nov. 19, 2026

(54) Crane And Method For The Automated Positioning And/Or Moving Of The Load-Receiving Means Of A Crane Of This Type

(71) Applicant: Liebherr-Werk Biberach GmbH, Biberach an der Riss (DE)

(72) Inventors: Mark Burkhardt, Biberach an der Riss (DE); Lena Joachim, Biberach an der Riss (DE); Andreas Gienger, Biberach an der Riss (DE); Norbert Haala, Biberach an der Riss (DE); Uwe Sörgel, Biberach an der Riss (DE); Oliver Sawodny, Biberach an der Riss (DE)

(21) Appl. No.: 19/477,075

(22) PCT Filed: Mar. 25, 2024
(86) PCT No.: PCT/EP2024/057903

§ 371 Date: Oct. 30, 2025

(30) Foreign Application Priority Data
Apr. 21, 2023 (DE) 10 2023 110 203.6

(51) Int. Cl. B66C 13/48; B66C 13/06; B66C 13/08

(52) U.S. Cl. CPC B66C 13/48; B66C 13/063; B66C 13/085

(57) ABSTRACT

A crane, in particular in the form of a rotating tower crane, that includes a boom which is pivotable about a vertical axis, and a hoist rope that runs from the boom, carries a load-receiving means such as a load hook, and can be lowered and raised by a lifting mechanism. In a method for automated positioning and/or moving of the load-receiving means of a crane, the load-receiving means is moved from an initial position to a target position and/or is moved in an automated manner along a path. In specific embodiments, the present invention is a method and a system for correcting positioning errors and/or deviations of the path of the load-receiving means in the absolute coordinates of a construction site.

### CROSS-REFERENCE TO RELATED APPLICATIONS

This application is a National Stage of International Application No. PCT/EP2024/057903 filed 25 Mar. 2024, which claims benefit under 35 USC § 365 of DE Application No. 10 2023 110 203.6 filed 21 Apr. 2023, each of which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a crane, in particular in the form of a rotating tower crane, comprising a boom which is pivotable about a vertical axis, and a hoist rope that runs from the boom, carries a load-receiving means such as a load hook, and can be lowered and raised by a lifting mechanism. The invention furthermore relates to a method for automated positioning and/or moving of the load-receiving means of a crane, in which the load-receiving means is moved from an initial position to a target position and/or is moved in an automated manner along a path. In this case, the invention also relates in particular to a method and a system for correcting positioning errors and/or deviations of the path of the load-receiving means in the absolute coordinates of a construction site.

### 2. Description of Related Art

For the automated construction of buildings, it is important to be able to perform load lifts of a crane in an automated manner, wherein the load attached to the load-receiving means has to be deposited at the desired target position and/or shifted along a desired lifting path with a sufficient degree of precision. The load-receiving means must also be able to receive the load at the desired starting position with sufficiently high precision.

In this case, it is important that the transported loads can be precisely positioned or moved in the absolute coordinates of the construction site, since the planning of a construction site is performed in a fixed, georeferenced construction site coordinate system. At the same time, a crane typically works in its own crane coordinate system. In order to be able to move to a target position or travel a certain lifting path with the load hook or load-receiving means, or also to be able to calculate this in advance, the crane controller specifies target coordinates or lifting path coordinates to the crane controller as drive coordinates in the crane coordinate system, such that the crane drives are then actuated accordingly and the load hook moves to the lifting path points or the target position. In the case of a rotating tower crane, the drive coordinates of the crane typically include the rotational angle about the vertical tower axis, the trolley position along the boom, and the rope length, as well as optionally the telescope length. Calibrating the crane position on the construction site makes it possible per se for the crane coordinate system to be compared with the georeferenced construction site coordinate system or the absolute coordinate system, and for example for a target position of a load in the georeferenced construction site coordinates to be transformed into crane coordinates.

In practice, however, owing to different circumstances, significant positioning errors or deviations from the desired lifting path occur hitherto.

On the one hand, positioning errors of the load hook or load-receiving means occur due to deformations of the crane structure. Cranes used on construction sites, such as rotating tower cranes or also mobile cranes with telescopic booms are ambitiously designed with regard to their bearing load, and have long, thin structures which deform significantly on account of the comparatively high bearing loads and also due to the not insignificant dynamic stresses. In the case of a rotating tower crane, in particular deformations of the tower occur, which tower sags forwards or in the radial direction, i.e. in a vertical longitudinal central plane, when a load is received on the boom, which leads to a type of pitching movement of the boom and influences the lowering depth or lifting height of the load hook. The boom itself also sags under the load or the lifting forces introduced by the hoist rope. In addition, transverse bending occurs transversely to the vertical longitudinal central axis of the crane, which extends through the tower longitudinal axis and the boom longitudinal axis, owing to dynamic loads which occur for example upon braking or acceleration of the slewing gear or on account of wind loads. In this case, the dynamic loads can act multiaxially, if the load oscillates or is accelerated by actuating the hoist rope.

On the other hand, positioning errors also occur for system-related reasons, due to the control of the lifting mechanism. Typically, the crane operator calibrates the lowering depth “zero” by pressing a button, when the load hook is located directly below the boom or 1 m or 2 m below the boom, and additionally also the ground level when the load hook is fully lowered, for example −60 m. Between these two reference points, the crane controller often calculates the lower depths by linear interpolation and controls the lifting mechanism drive accordingly, which, however, in practice is not entirely correct or can be associated with significant errors, since a rotation of the rope winch drum does not result in the same unwinding length or reel-in length over the entire lowering depth range. This results from multilayer winding of the hoist rope on the drum, which changes the actual winding radius.

In addition, there are path errors on account of errors in the sensor evaluation or sensor deviations, as soon as the crane hook position in a fixed georeferenced construction site system is taken into account.

These systematic deviations are associated with positioning errors in the absolute construction site coordinate system, which are a problem in the case automated lifting of the crane. Without correction, positioning errors of significant orders of magnitude may arise, for example in the lowering dept of 1 m or also 2 m, which may have drastic consequences when depositing a load.

Modern cranes have pendulum damping systems which monitor crane movements by means of a comprehensive sensor system and sensor evaluation, and engage in the control of the crane drives in a corrective manner, in particular in the control of the slewing gear, by which the boom is rotated about the vertical axis, of the trolley travel drive, by which the trolley can be moved along the boom, and of the lifting mechanism, by which the load hook can be raised and lowered. In this case, it has already been proposed to take structural deformations of the crane into account for the pendulum damping, in particular the sagging of the tower and of the boom, cf. for example EP 37 84 616 A1. However, the mentioned positioning errors in the georeferenced construction site system, as described above, cannot be eliminated.

These systematic positioning errors in the absolute coordinate system are countered, to date, in that the actual, absolute crane hook position in the georeferenced construction site coordinates is monitored, for which purpose special position sensor means are used, for example a Global Navigation Satellite System (GNSS) sensor module on the crane hook or a tachymeter or also local sensor tags which operate in the ultra-wide-band range and which can comprise one or more tags at calibrated positions of the construction site, as well as one or more tags on the crane. However, such absolute position-sensing systems are very expensive, and their operation may be associated with errors in certain use conditions, such as unfavorable weather or environmental conditions or interfering objects such as steel structures or transmitters in the direct surroundings. In this case, installations of peripheral devices and cables are often also required, which may sometimes be difficult or even impossible to implement, depending on the construction site.

It is therefore an object of the present invention to provide an improved crane, and an improved method of the type mentioned at the outset, which overcome the disadvantages of the prior art and develop the prior art in an advantageous manner. In particular, automated lifts without or with only negligibly small positioning errors or deviations from the lifting path should be made possible, without requiring permanent monitoring by expensive absolute sensor systems.

### BRIEF SUMMARY OF THE INVENTION

According to the invention, the problem is solved by a method for the automated positioning and/or automated moving of the load-receiving means of a crane, in particular the load hook of a rotating tower crane, the method comprising the steps of, in a calibration phase, collecting training data that characterizes positioning errors of the load hook in various regions of the working region of the crane and for various lifting loads on the load-receiving means, by means of the steps of moving to various intended positions and/or travelling various intended paths of the load-receiving means by controlling the drives of the crane by means of a crane controller, sensing the actual positions actually moved to and/or the travelled actual path of the load-receiving means by means of a position-sensing device in absolute coordinates, determining a crane model which describes the positioning errors of the crane over its working region for various lifting loads, by regression of the collected training data, in a compensation and/or working operation phase sensing a lifting load received and/or to be received on the load-receiving means, correcting the intended target position and/or the intended path of a load lift on the basis of the determined crane model according to the sensed lifting load, and controlling the drives of the crane by means of the crane controller on the basis of the corrected intended target position and/or the corrected intended target path.

According to the invention, the problem is also solved by a crane, in particular a rotating tower crane, comprising a boom which is pivotable about a vertical axis, and a hoist rope that runs from the boom, carries a load-receiving means such as a load hook, and can be lowered and raised by a lifting mechanism, and an electronic crane controller for controlling the drives of the crane, in particular a slewing gear, a trolley travel drive and a lifting mechanism, characterised in that the crane controller comprises a calibration module and a compensation module, wherein the calibration module is configured, in a calibration phase, for collecting training data that characterise positioning errors of the load hook in various regions of the working region of the crane and for various lifting loads on the load-receiving means, by means of the steps of moving to various intended positions and/or travelling various intended paths of the load-receiving means by controlling the drives of the crane by means of a crane controller, collecting position data of the actual positions actually moved to and/or the travelled actual path of the load-receiving means, provided by a position-sensing device in absolute coordinates, determining a crane model which describes the positioning errors of the crane over its working region for various lifting loads, by regression of the collected training data, and the mentioned compensation model is configured, in a working operation phase, for sensing a lifting load received and/or to be received on the load-receiving means, correcting the intended target position and/or the intended path of a load lift on the basis of the determined crane model according to the sensed lifting load, and controlling the drives of the crane by means of the crane controller on the basis of the corrected intended target position and/or the corrected intended target path.

According to the invention, the problem is also solved by a method for correcting positioning errors and/or deviations of the path of a load-receiving means of a crane in georeferenced coordinates of a construction site, comprising the steps of collecting training data that characterise positioning errors of the load hook in various regions of the working region of the crane and for various lifting loads on the load-receiving means, by means of the steps of moving to various intended positions and/or travelling various intended paths of the load-receiving means by controlling the drives of the crane by means of a crane controller, sensing the actual positions actually moved to and/or the travelled actual path of the load-receiving means, by means of a position-sensing device in absolute coordinates, determining a crane model which describes the positioning errors of the crane over its working region for various lifting loads, also for portions of the working operation in which no target positions and/or target paths were moved to, by regression of the collected training data.

According to the invention, the problem is also solved by a system for correcting positioning errors and/or deviations of the path of a load-receiving means of a crane in georeferenced coordinates of a construction site, comprising a calibration module and a compensation module, wherein the calibration module is configured, in a calibration phase, for collecting training data that characterise positioning errors of the load hook in various regions of the working region of the crane and for various lifting loads on the load-receiving means, by means of the steps of moving to various intended positions and/or travelling various intended paths of the load-receiving means by controlling the drives of the crane by means of a crane controller, sensing the actual positions actually moved to and/or the travelled actual path of the load-receiving means, by means of a position-sensing device in absolute coordinates,—determining a crane model which describes the positioning errors of the crane over its working region for various lifting loads by regression of the collected training data, and the mentioned compensation module is configured, in a working operation phase, for sensing a lifting load received and/or to be received on the load-receiving means, correcting the intended target position and/or the intended path of an automated load lift on the basis of the determined crane model according to the sensed lifting load.

It is thus proposed to operate the crane, prior to normal crane operation, with automated lifts in a calibration phase, in which the positions actually moved into or travelled during movement of the load-receiving means are monitored using a sensor system operating in georeferenced absolute coordinates, and are compared with the positions sensed in the crane coordinate system and/or predetermined positions, in order to determine occurring positioning errors in the georeferenced absolute coordinates. A model is determined from the training data recorded in the calibration phase, with the aid of which model positioning errors can also be estimated or determined for positions and/or lifting paths for which there are no position data in the sensor system operating in absolute coordinates, such that the crane can operate in a later normal crane operation phase with automated lifts without monitoring by the absolute sensor system, and a correction of the positioning errors can be performed on the basis of the positioning errors estimated by means of the model.

In this case, in the calibration phase and in the normal working operation phase the following steps can be performed:

In the calibration phase, training data are collected which characterise positioning errors of the load hook in various portions of the working region of the crane and for various lifting loads on the load-receiving means, wherein for collecting the training data various target paths are travelled with the load-receiving means, in that the drives of the crane are controlled by the crane controller, and the actual positions actually moved to and/or the actually travelled actual paths are sensed by a position-sensing device operating in absolute coordinates. A crane model is then determined on the basis of the collected training data by regression of the mentioned training data, which model describes the positioning errors of the crane over its working region for various loads.

In the normal working operation phase with automated load lifts, the respective lifting load received or to be received on the load-receiving means is then sensed by sensor means, in order to correct the intended target position and/or the intended path of the load-receiving means for the automated load lift, depending on the sensed lifting load and on the basis of the determined crane model, and then to control the crane drives by the crane controller on the basis of the intended target position corrected in this way and/or of the target lifting path.

The crane model determined by regression of the training data makes it possible to estimate the positioning errors, occurring in the georeferenced construction site coordinates, over the entire working region of the crane, and thus also to determine them for positions or portions of the working region in which previously, in the calibration phase, no measurements were made using the absolute sensor system. Irrespective of whether positions moved to in the calibration phase for training purposes, or a portion of the working region travelled over for training purposes, are intended to be moved to or travelled, the crane can work in normal crane operation with automated lifts without monitoring by a position-sensing sensor system operating in absolute coordinates and nonetheless determine the positioning errors, occurring systematically or due to sagging, in absolute coordinates, and correct the target position to be moved to or the lifting path to be travelled on the basis of the estimated or determined positioning error.

Thus, the present invention achieves the essential advantage that, after a calibration phase, the positioning accuracy of the crane in georeferenced coordinates can be improved without additional and usually very expensive measuring systems. In this way, a permanent and often complex installation of such measuring systems can be saved. The mentioned calibration and compensation phases can generally be applied to any crane types, but, however, are particularly advantageous for cranes with long, thin and ambitiously designed structures, which exhibit significant deformations under loads and operated with long hoist rope lengths. Furthermore, increased safety can be achieved by the system per se, and the automation of the construction of buildings, planned in a fixed construction site coordinate system, can be advanced further.

In a development of the invention, in the calibration phase, for collecting training data the lifting loads received on the load-receiving means, and the target positions moved to or lifting paths travelled are varied in wide ranges within the bearing load region or the working region of the crane, in order to be able to obtain training data that are as meaningful as possible. For example, various lifting loads can be received, and changed in the range of the crane, for example by moving the trolley drive, in order to represent at least 75% of the bearing load region as training data. Alternatively or in addition, lifting paths can be travelled and/or target positions can be moved to which represent at least 75% of the radial range. Alternatively or in addition, lifting paths can be travelled and/or target positions moved to that represent at least 75% of the lifting height, i.e. loads are for example lifted from the ground level up to close to the boom, or, vice versa, lowered. Large regions can be travelled in the horizontal plane too, wherein preferably at least the edge regions of the working region of the crane can be travelled with training runs.

In a development of the invention, in the calibration phase, simultaneously in real time on the one hand the positioning signal of the positioning sensor system operating in absolute coordinates, and on the other hand sensor signals and/or evaluation sensor signals and/or control signals are sensed, which are stored in crane coordinates by the crane controller and/or sensor systems present on the crane, as training data.

In this case, essentially different items of crane data can be collected as training data, in particular position data which determine the respective position of the crane drives and/or the crane components driven thereby, for example the rotational angle of the boom about the vertical axis, the trolley position along the boom, and the unwinding length of the hoist rope and/or the rotational position of the hoist rope drum. Depending on the sensor system present on the crane, other crane operating parameters can also be collected as training data, for example elongations of the crane structure, such as elongations in the longitudinal chords of the tower, bending strains of the tower and/or of the boom in one or more axes, and in particular also travel speeds of the mentioned crane drives, i.e. rotational speeds about the vertical axis and/or trolley speeds and/or hoist rope speeds. Alternatively or in addition, accelerations can also be sensed by sensors and/or derived from other variables sensed by sensors and collected as training data, for example hoist rope accelerations, load hook accelerations, trolley accelerations and/or rotational accelerations about the vertical axis.

The sensor system that is used in the calibration phase and works in absolute coordinates can in principle be designed in different ways. In an advantageous development of the invention, at least one GNSS sensor can be used, for example fastened to the load hook or the load-receiving means. Alternatively or in addition, such GNSS sensors can also be attached to other crane components, such as the trolley and/or the boom tip.

Alternatively or in addition to such GNSS sensors, a tachymeter system can also be used, in order to sense the position of the load-receiving means of the crane and optionally also other crane components such as the trolley, in absolute coordinates, wherein optical and/or electronic tachymeters can be used here. Preferably, tachymeters with automated target sensing can also be used.

Alternatively or in addition, the absolute sensor system can also work with optical sensing systems such as cameras, which determine the position of the load hook and possibly also other relevant crane components such as the trolley, in absolute coordinates.

Alternatively or in addition, the absolute sensor system can also comprise local, wireless signal transmission/receiving means, which can for example sense signal transit times and/or signal strengths. For example, ultra-wide-band tags can be provided, which on the one hand are mounted on a location calibrated in the georeferenced coordinate system or on a plurality of georeferenced positions, and on the other hand are attached at one or more positions on the crane, for example on the load hook and on one or more positions of the boom, in order to determine the absolute position of the load-receiving means from the signals exchanged between the tags, their transit times, and/or their received signal strengths.

In a development of the invention, a linear regression can be performed in the regression of the training data, preferably with non-linear basis functions.

Preferably, in the regression trolley positions to the second power and/or third power can be taken into account, in order to achieve improved accuracies, in particular to better represent deformations of the boom. Squared and cubic trolley positions allow a more precise prediction of bending of the boom in the vertical direction, since the bending curve of the boom can be described by a third-order polynomial, at least if it is assumed that there is no load distribution or all the line loads distributed over the boom can be ignored.

In particular, a so-called LASSO algorithm, i.e. “least absolute shrinkage and selection operator” can be used in the regression, in order to select the most relevant parameters or properties of the training data.

In the compensation phase, the positioning errors can be corrected in various ways. For example, path points defining a lifting path can be corrected, in that the positions or coordinates defining the lifting path are shifted point-by-point.

Alternatively or in addition, a correction of the trajectory can also be performed in the positioning correction, which characterises the target path of the load hook.

These and other objects, features and advantages of the present invention will become more apparent upon reading the following specification in conjunction with the accompanying drawing figures.

### BRIEF DESCRIPTION OF THE DRAWINGS

The invention is explained in more detail below with reference to a preferred embodiment and the corresponding drawings. The drawings show:

FIG. 1 is a side view of a crane according to an advantageous embodiment of the invention in the form of a rotating tower crane.

FIG. 2 is a schematic, perspective view of the crane from FIG. 1, for illustrating the degrees of freedom and the crane coordinate system.

FIG. 3 is an illustration of a lifting path which was determined by a lifting path planner along a plurality of path points.

FIG. 4 is a schematic side view of the crane from FIGS. 1 and 2 for illustrating the arising positioning errors.

FIG. 5 is a perspective view of a lifting path around different objects, wherein work limitations are shown by a black frame.

FIG. 6 is an illustration of a lifting path which is travelled in the calibration phase with a GNSS sensor attached to the load hook.

FIG. 7 is an illustration of the positioning error in polar coordinates in measured absolute coordinates, compared with the positioning error estimated by the crane model.

FIG. 8 is an illustration of the load hook positions in the fixed crane coordinate system, wherein in addition to the target path the correction paths are shown in dashed lines and the target path measured in absolute coordinates is shown.

FIG. 9 is an illustration of the positioning error in polar coordinates, corresponding to the illustrations in FIG. 8.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

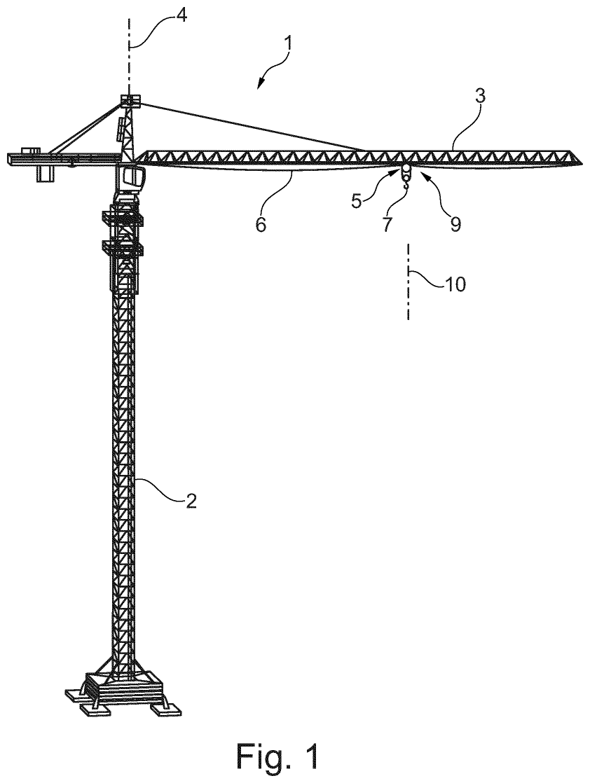

As FIG. 1 shows, the crane 1 can be configured as a rotating tower crane, the tower 2 of which bears a boom 3 which can be rotated by a slewing gear about a vertical axis 4, in particular the tower longitudinal axis. A trolley 5 can be moved along the boom 3 by a trolley drive rope 6, in order to change the range of the load hook 7. The trolley travel rope 6 can be adjusted by a corresponding trolley travel drive.

The load hook 7 can be lowered or raised from the boom 3 by a hoist rope 9, in order to be lowered and raised along the vertical axis 10, cf. FIG. 1.

The planning level of the construction site typically works with a locally fixed, georeferenced coordinate system, which requires absolute positioning of the transported payload, from automated rotating tower cranes. However, the error, which contains bending displacements, sensor offset, and sensor evaluation errors can hitherto not be compensated, even by modern controllers which work only with relative sensors on the rotating tower crane. The corresponding path error leads to the payload deviating from the desired path, which can lead to collisions with obstacles.

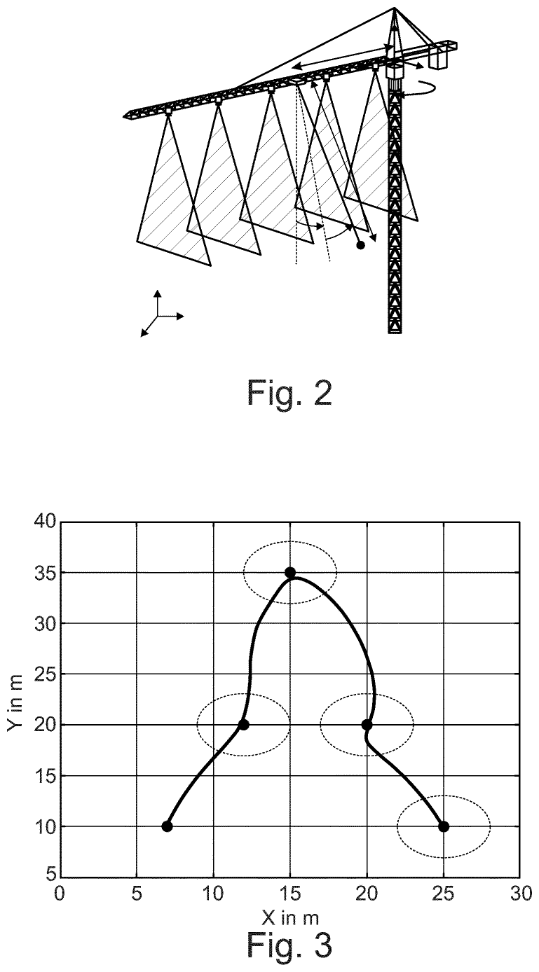

The degrees of freedom and the crane coordinate system K are highlighted in FIG. 2.

In this case, the rotating tower crane 1 transports payloads with mass mₚₗ, in that it suspends them on the crane hook 7. The rotating tower crane 1 can be equipped with at least three drive systems. The swivel drive actuates a joint below the tower crane cab or, in the case of a lower turner, pivots the entire tower 2 including the boom 3, which determines the pivot angle γ of the boom. The trolley travel drive controls the trolley position xₜᵣ, and the lifting drive changes the rope length lᵣ.

In this case, the movement of the drives can cause an oscillation of the payload with the pivot angles Φₓ in the vertical direction and Φ_{y} in the radial direction of the boom. The origin of the crane coordinate system K is located, according to FIG. 2, above the cab.

An oscillating-damping controller known per se, and a trajectory tracking controller, can be provided for the rotating tower crane 1, in order to perform automated load lifts. In this case, it can be provided that the resilient degrees of freedom, on which the bending of the tower 2 in the radial direction qᵥₓϵR² and in the tangential direction q_{vy}, and that of the boom 3 in the tangential direction q_{wy} and in the vertical direction q_{wz} are based, are taken into account.

For this purpose, in the following the vector that contains all the degrees of freedom of the rotating tower crane is considered as follows:

q=[φₓ,φ_{y},q_{vxT},q_{vy},q_{wy},q_{wz}]∈R⁷ (1)

wherein the state vector of the rotating tower crane is defined as x=[q,\dot{q}]^{T}, while the corresponding target state trajectory is denoted as follows: x_{d}.

Sensors of the drive systems measure the positions q_{d}=[γ, xₜᵣ, lᵣ]^{T} and the speeds \dot{q}_{dr}=[\dot{γ}, \dot{x}ₜᵣ,\dot{l}ᵣ]^{T}. The target positions and speeds of the drive systems are indicated by q_{dr,d} and q_{dr,d}, the control inputs to the drive systems are indicated by u.

The fully automatic payload transport or automated payload lift is prepared by planning a collision-free crane hook path to a predetermined target location, which furthermore corresponds to the lifting path, and calculating the corresponding trajectory in the coordinate system K. In this case, an algorithm that is known per se can be used for the path planning. In this case, the path planning algorithm preferably calculates a sequence

P=(p₁, . . . ,p_{N}_{ₚ}) (2)

of Nₚ so-called path points pi, which represent a collision-free path from a start location to a target location with respect to the common georeferenced ground coordinate system G and can be optimized according to specific criteria. In this case, the lifting path can be calculated using an algorithm, also known per se, between each successive point pair pᵢ and pᵢ₊₁, wherein the hook position can correspond to the flat output z of the system. The derivation of the target state trajectory

$${x}_{d} = {ψ}_{x} ( {z}_{d} , … , {\ddot{z}}_{d}^{*} )$$

and the forwards control input trajectory

$${u}_{F F} = {ψ}_{u} ( {z}_{d}^{*} )$$

can be obtained from the desired lifting trajectory and its derivations

$${z}_{d}^{*} = [ {z}_{d} , ... , {z}_{d}^{( 4 )} ] ,$$

using the flat parameterizations ψx, ψᵤ.

In order to ensure a continuous movement of the hook, a sphere having a specified radius around the sphere center point pᵢ is defined for all i=1, . . . , Nₚ. As soon as the crane hook intersects the sphere, while it follows the target trajectory pᵢ, the crane determines an updated lifting path at pᵢ₊₁. A lifting path by way of example is shown in FIG. 3.

Overall, the crane operates in its own crane-centered coordinate system K, but all other processes on the construction site are planned by the planning level with respect to the common georeferenced ground coordinate system G. Therefore, in a preceding step, the transformation between the ground coordinate system G and the crane system K is determined by measurements, preferably for the case where no load hangs on the hook, the hoist rope is as short as possible, and the trolley is positioned close to the tower, under the boom. In this case, G can be the local UTM projection. Within G, the actual hook position

z=FK(x,q_{d})+e_{bend}+e_{off}+e_{obs} (3)

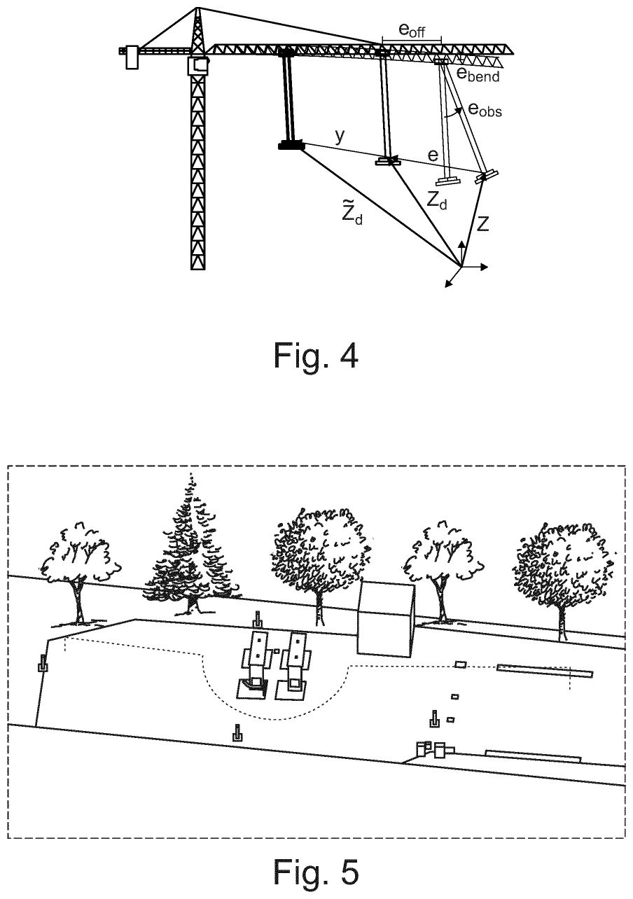

can be calculated by the forward kinematics FK(x, q_{d}) based on the nominal solid body model, and an error can be calculated that can result from the bending e_{bend} of the tower 2 and of the boom 3 of the rotating tower crane 1, as well as the extension of the lifting cable 5, sensor deviations e_{off} and sensor evaluation errors e_{obs}. These error sources are shown in FIG. 4.

The path error is then defined as

e=z_{d}−z=FK(x_{d},q_{dr,d})−FK(x,q)−e_{bend}−e_{off}−e_{obs}. (4)

The path error e also includes the control error FK(x_{d}, q_{dr}, d)−FK (x, q) of the trajectory tracking controller. The sensor deviations result in the drive systems stopping at constantly shifted positions. Furthermore, the sensor evaluation errors should not be ignored, since validation measurements have shown that the pendulum angle in the radial direction Φ_{y} is incorrectly evaluated by up to 3°, which leads to a path error in particular at transitions.

In order to compensate the mentioned path error e, a first step can consist in predicting the path error. The prediction of the error e is performed using a regression model.

The three components [γₑ, Δx_{tr,e}, ΔZₑ]^{T}, which represent e in polar coordinates, are considered to be results of the regression model. The error of the rotational angle Δγₑ is calculated with reference to the origin of the coordinate system fixed to the tower crane. The output y of the regression model is therefore defined as follows, on the basis of a linear regression:

$$y = {[ {Δγ}_{e} , Δ {x}_{tr , e} , Δ {Z}_{e} ]}^{T} = {[ {f}_{γ}^{T} {Θ}_{γ} , {f}_{tr}^{T} {Θ}_{tr} , {f}_{Z}^{T} {Θ}_{Z} ]}^{T} \qquad ( 5 )$$

wherein

f_{ξ}=[1, [symbol] , . . . , [symbol] ]^{T}∈R [symbol] , (6)

Θ_{ξ}=[ [symbol] , . . . , [symbol] ]^{T}∈R [symbol] , (7)

for [symbol] ∈(γ, xₜᵣ, Z). The constants [symbol] describe the number of features that are used for the prediction of each component. The coefficients [symbol] are determined by a regression adjustment algorithm, which is applied to the training data. The training data preferably include measurements of features [symbol] and the respective errors Δγₑ, Δx_{tr,e} and ΔZₑ. Possible features are the target state trajectory x_{d}, the state vector x which is calculated by the sensor evaluation, the positions q_{dr} and the speeds q_{dr} of the drive systems of the rotating tower crane, the payload mₚₗ measured by the load sensor, and the control commands that are calculated by the implemented controller. Further features are the squared and cubic trolly position [symbol] and the approximated payload fluctuation distances lᵣΦₓ and lᵣΦ_{y}. The squared and cubic trolley position can allow for a more precise prediction of the bending of the boom in the vertical direction, since the deflection curve of the boom is a third-order polynomial in xₜᵣ, assuming that there is no vertical load.

All the features taken into account are summarized as follows:

$$d = {[ {x}^{T} , {q}_{dr}^{T} , {q}_{dr}^{\dot{T}} , {m}_{pl} , {u}^{T} , {x}_{d}^{T} , {q}_{dr , d}^{T} , {q}_{dr , d}^{\dot{T}} , {x}_{tr}^{2} , {x}_{tr}^{3} , {l}_{r} {ϕ}_{x} , {l}_{r} {ϕ}_{y} ]}^{T} \qquad ( 8 )$$

with 48 entries. In order to identify the most relevant features for each output and to avoid overmatching, a so-called LASSO regularization is calculated for each output Ψ∈(Δγₑ, Δx_{tr,e}, ΔZₑ) using training data. More precisely, the optimization problem

$$min ( {ω}_{ξ} ) ( \frac{1}{2 N} {\sum }_{k = 1}^{N} {( {Ψ}_{k} - [ 1 , {d}_{k} ] {ω}_{ξ} )}^{2} + λ {\sum }_{j = 1}^{{N}_{ξ}} \vert {ω}_{ξ , j} \vert ) \qquad ( 9 )$$

can be solved for various values of λ with MATLAB Simulink. In this case, the index k stands for the time stamp of the training data. The coefficients [symbol] ∈R⁴⁹ and their components [symbol] denote the unknown coefficient vector, when al 48 features and a constant offset are taken into account.

The higher the value for λ, the more coefficients ω_{ξ} are zero, while the remaining coefficients sufficiently minimize the squared error between the measured output and the outputs of the regression model, and thus specify the features that are most suitable for the reconstruction of the respective output.

After examining the non-zero coefficients of the solution for a plurality of values of λ, the following features are obtained for the prediction of the error by regression

$${f}_{γ} = {[ 1 , {ϕ}_{x} , {q}_{wy} , \dot{γ} , {\dot{ϕ}}_{x} , {x}_{tr} , {l}_{r} , {u}_{γ} , {x}_{tr , d} , {l}_{r , d} , {\dot{l}}_{d} , {ϕ}_{x , d} ]}^{T} , \qquad ( 10 a )$$

$${f}_{tr} = {[ 1 , {ϕ}_{y} , {q}_{vx}^{T} , {\dot{ϕ}}_{y} , {l}_{r} , {m}_{pl} , {u}_{tr} , {u}_{r} , {x}_{tr}^{3} ]}^{T} , \qquad ( 10 b )$$

$${f}_{z} = {[ 1 , {q}_{vx}^{T} , {l}_{r} , {m}_{pl} , {u}_{tr} , {u}_{r} , \dot{{l}_{γ , d}} , {x}_{tr}^{3} ]}^{T} . \qquad ( 10 c )$$

The features (10a) for the prediction Δγₑ do not contain the payload mₚₗ. The influence of the sagging of the boom in the tangential direction q_{wy} exceeds the influence of mₚₗ. The pendulum angle Φₓ and the target angle Φ_{x,d} are both relevant features, since their difference directly determines Δγₑ, which is also an angle. The features (10b) of the prediction of Δx_{tr,e} do not contain the product Φ_{y}lᵣ and instead contain the pendulum angle in the radial direction Φ_{y} and the crane rope length lᵣ. The radial bending of the tower qᵥx is more important than the vertical bending q_{wz} of the boom. With respect to ΔZₑ, the most important features in (10c) are the load mₚₗ and the cubic trolley position

$$x \frac{3}{tr} ,$$

which represents the deflection curve depending on the chassis position.

In a further step of the derivation of the regression model, the coefficients [symbol] are calculated with the aid of the iteratively newly weighted algorithm for adjustment according to the least squares method. The result of the regression model is thus formulated as follows:

$$y ( x , {q}_{dr} , {\dot{q}}_{dr} , {m}_{pl} , u , {x}_{d} , {q}_{dr , d} , \dot{{q}_{dr , d}} , {x}_{tr}^{3} ) = {[ {f}_{γ}^{T} {Θ}_{γ} , {f}_{tr}^{T} {Θ}_{tr} , {f}_{Z}^{T} {Θ}_{Z} ]}^{T} . \qquad ( 11 )$$

For compensating path and positioning errors, several approaches for calculating a corrected lifting path [symbol] and the corresponding lifting trajectory [symbol] can be applied, wherein the target state trajectory [symbol] and the forwards control [symbol] of the rotating tower crane can be converted into georeferenced coordinates, for more precise tracking of the planned path. The corrected trajectories are denoted by [symbol] and [symbol] .

In this case, the correction and the measurement results of a load lift by two different approaches are shown in FIG. 4. The corrected hook position [symbol] is in each case highlighted in red and blue dashed lines, and results from shifting the target hook position z_{d} by the predicted path error y, as a result of (11). The control of the rotating tower crane aims to position the hook at the compensation position [symbol] . On account of the path error that still exists, the hook position is the same as the desired hook position z_{d} (black in FIG. 4), which is the overall aim.

The path calculated using the path planning algorithm (8) consists only of a sequence of points in the working space of the rotating tower crane. Therefore, the only known features of (10) are the positions of the drive systems q_{dr} and the permanently measured load mₚₗ at these points. Therefore, in a first approach (blue in FIG. 4) the regression model is evaluated at the position of each path point, with the assumption that the hook is in the stationary state. The remaining features which are required for the prediction by the regression model are not known. Assuming that the path calculated by the path planning algorithm used is described as a quantity P=(p₁, . . . , p_{Np}), wherein the Nₚ points describe the path points in polar coordinates in K, the corrected path points are obtained by

$${\tilde{p}}_{i} = {p}_{i} + y ( 0 , {p}_{i} , 0 , {m}_{pi} , 0 , 0 , {p}_{i} , 0 , {x}_{tr}^{3} ) . \qquad ( 12 )$$

Therein, the drive systems q_{dr} are set to pᵢ. Ignoring all other features reduces the quality of the predicted error y in (12) and the regression model therefore describes only static deflections and sensor shifts. The corrected lifting path [symbol] and the corresponding lifting trajectory [symbol] are used by applying the algorithm described above, for generating paths, to the set of compensation path points [symbol] ={ [symbol] , . . . , [symbol] }. The flat parameterizations ψₓ, Ψᵤ then result in the target state trajectory [symbol] and the forwards control input [symbol] which are supplied to the trajectory tracking controller.

Alternatively, or in addition, as a second approach the corrected lifting path [symbol] and the lifting trajectory [symbol] can be calculated based on the desired lifting path of the hook [symbol] In this case, the state trajectory x_{d} includes the expected pendulum angle, resilient degrees of freedom and travel speeds. Assuming that the lifting trajectory is followed perfectly, then x=x_{d} and u=u_{FF}. Then, the sensor values of the positions of the drive systems q_{dr}=q_{dr,d} and the speeds q_{dr}=q_{dr,d} are also equal to the values of the corresponding target values. The corrected path points can then be calculated according to:

$$\text{?} = {z}_{d} + y ( {x}_{d} , {q}_{dr , d} , \dot{{q}_{dr , d}} , {m}_{pl} , {u}_{FF} , {x}_{d} , {q}_{dr , d} , \dot{{q}_{dr , d}} , {x}_{tr , d}^{3} ) . \qquad ( 13 )$$

However, it should also be noted that only the position of the hook in polar coordinates is corrected. The derivations [symbol] do not correspond to the compensated position [symbol] . Therefore, the derivations [symbol] of the corrected lifting path [symbol] are calculated, in that the trajectory generation algorithm, present per se, is used again for a new set of path points which are defined as follows:

$$\text{?} = \{ {p}_{i} ∈ {R}^{3} \vert {p}_{i} = \text{?} ( {t}_{i} ) , i = 0 , ... , {N}_{t} \} , \qquad ( 14 )$$

wherein the time stamps tᵢ are distributed uniformly over the time period, which describes the transition between the starting and target location. The time stamps tᵢ are thus determined by tᵢ=iΔt with

$$Δ t = \frac{max \{ {T}_{γ} , {T}_{tr} , {T}_{Z} \}}{{N}_{t}} ,$$

wherein T_{γ}, Tₜᵣ, T_{Z} is the transition time in each coordinate of [symbol] . The application of the trajectory algorithm to [symbol] gives and thus the target state trajectory [symbol] as well as the forwards control input [symbol] after use of the flat parameterization.

In order to validate the regression model (11) using experimental data and examination of the performance of the presented approaches for error compensation, a payload with a weight of 1000 kg was moved from a starting point to a target point in the working region of the rotating tower crane 1 using a real Liebherr 154 EC-H Litronic 6 large tower crane, as shown in FIG. 1. The starting and target point are given by

p₁=[202°,24.5m,16m]^{T}, p₁₀₅=[29°,34m,17m]^{T}. (15)

The path planning algorithm calculates path points between the starting and target location, taking into account the fact that the payload may not be moved through restricted regions in the working region of the rotating tower crane, and minimizes the overall path length. The resulting path points consist of 105 points, which are shown in FIG. 5.

It should be noted that a vertical transition of 1 m exists between the last two points p₁₀₄ and p₁₀₅. The desired hook path z_{d} is calculated with the aid of the trajectory algorithm. The trajectory tracking controller of the rotating tower crane is used for the path tracking and damps the swaying of the payload.

The training data can be obtained by performing a plurality of benchmark payload transitions, preferably at the edge of the working region of the rotating tower crane. The features (10) and the path tracking errors (4) are plotted, while a GNSS sensor is attached to the hook 7 of the rotating tower crane 1. The georeferenced position of the GNSS sensor is determined with real-time kinematics, which achieves a precision of up to 2 cm.

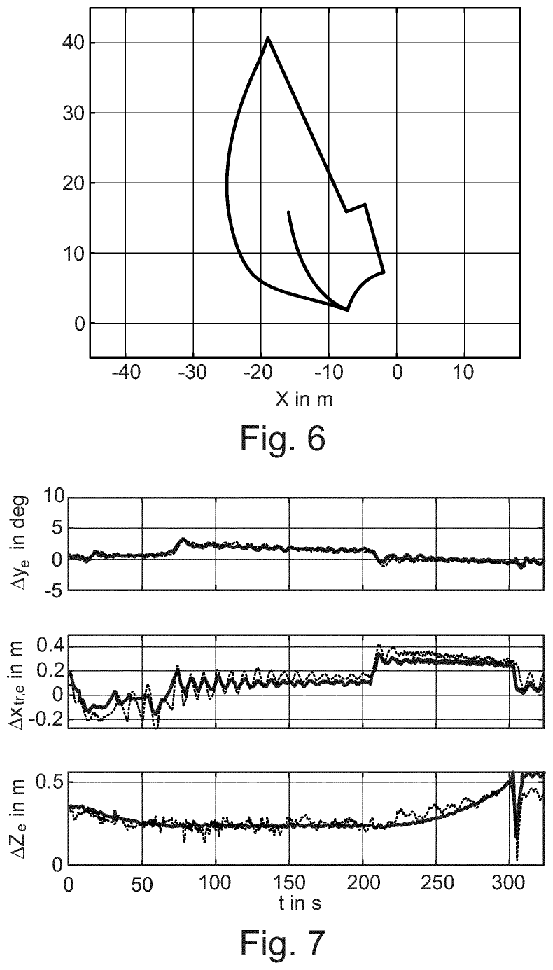

The benchmark transitions consist of a transition in the pivot direction, a transition in the radial direction, a combination of a pivot and a radial transition, and a combination of a pivot, a radial and a vertical transition. The target hook position of all the benchmark transitions is highlighted in red in FIG. 6. If the training data are considered as a whole, then points 1 to 6 are padded through only for two different rope lengths and transported payloads of 0 t and 2.25 t. The latter is the maximum payload which may be lifted using the test crane at a trolley position of 35 m.

FIG. 7 shows the error (11) predicted with the regression model, and the error e which was reconstructed on the basis of the measurement data.

During tϵ[70.215], the boom bends in the horizontal direction counter to the pivot direction, such that Δγₑ increases. The error Δx_{tr,e} is negative at the start of the automated load lift, because the radial target hook position is smaller than the actual radial hook position. This is caused by an incorrect determination of the actual hook position by the sensor evaluation of the rotating tower crane, since the sensor evaluation of the pivot angle in the radial direction has a smaller value than the actual one.

During the pivot movement, Δx_{tr,e} remains constant, which means that the position of the trolley 5 is shifted. If the trolley 5 is moved away from the tower 2, the same sensor evaluation error results as in the case of the movement of the trolley 5 towards the tower 2. Since the movement direction is changed, Δx_{tr,e} even becomes greater at t≈215 s.

The vertical error ΔZₑ is dominated by the static bending of the boom 3 and the extension of the crane rope. In wide-range trolley positions, the bending torque acting on the boom 3 is greater, and therefore the payload hangs lower, and the error thus increases. Since the scenario is ended by lowering the payload by 1 m, the target height becomes smaller. Since the lifting drive is moved with a brief delay, the target height is equal to the real height and causes ΔZₑ=0 during a short time span of t≈303 s.

The average absolute errors (MAE) between the result of the regression model and the measured error are given by MAE_{γ}=0.24°, MAEₜᵣ=5.4 cm, and MAE_{Z}=3 cm. All MAEs are influenced by the measuring accuracy of the GNSS sensors, which is at best approximately 2 cm. Since the MAEs have almost the same values as the measuring accuracy, the prediction by the regression model functions impressively well. The remainder of the MAEs result from the fact that only measurements for different transitions and different payloads or incidental interference such as wind or the bearing clearance of the slewing gear are included.

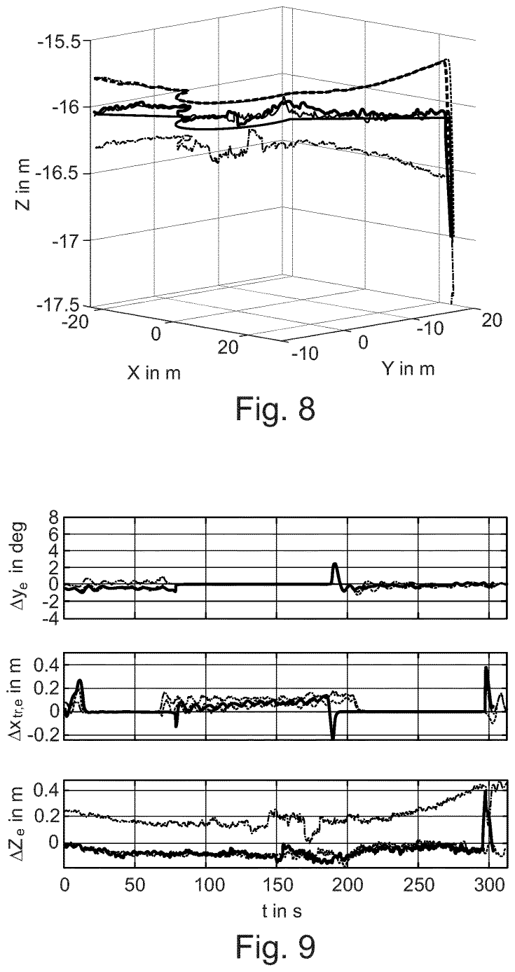

FIG. 8 shows the desired lifting path z_{d} (black), the corrected lifting paths [symbol] (dashed) and the GNSS position of the crane hook (solid line) which were measured during the tracking of the desired lifting path (green) and during the tracking of the lifting path corrected by the first (blue) and second (red) above-mentioned approach approximation. The time grid for the determination of the compensation path by the second approximation z_{d,2} is calculated with Nₜ=105.

It should be observed that the height of the dashed compensation paths increases more, the further the carriage is moved away from the tower. This is important because the bending deviation of the tower and of the boom is larger the further the trolley is away from the tower. Therefore, the green line falls away while the solid red and blue line remain in the same horizontal plane. The bending in the vertical direction is not completely eliminated, since there is an offset between the black and the solid blue or red line. This offset is in the region of the MAE determined in the previous sub-paragraph, and is also justified by the negatively influenced measuring accuracy of the GNSS sensors. The results also show that the accuracy of the GNSS sensors used is significantly adversely affected by the metal structure of the crane. Although real time kinematics are used, high peaks occur in the solid green, red and blue lines, in the center and at the end of the pivot process.

FIG. 9 shows the components of the path error. It should be noted that the correction of the individual path points leads to a different transition time between the individual path point pairs. Thus, the overall path obtained by the first and second approaches have different transition times from the original black path. For assessing the path tracking error, the components Δγₑ, Δx_{tr,e} and ΔZₑ are determined by formulating the vector which links each GNSS measurement with the next point on the target path, in polar coordinates. Consequently, the errors Δγₑ and Δx_{tr,e} are equal to zero during tϵ[83.187] or tϵ[20.66] and tϵ[211.294], which is due to the fact that the components are determined by the next point, respectively, on the desired lifting path, which has the same pivot angle or the same chassis position.

Owing to the good performance of the tracking controller, the errors Δγₑ and Δx_{tr,e} are already small and are also dominated by unexpected interference, which leads only to a small improvement of the results. This interference includes wind gusts, a permanently occurring oscillation during movement of the payload, and bearing clearance. During the long extension in the time interval tϵ[70.210] the offset in the chassis position Δx_{tr,e} is eliminated by both approaches.

The path error that results from the tracking of the compensation path generated with the second approach results in relatively large peaks at the end of the long curve at t≈190 s and after the lowering of the payload at t≈295 s. These peaks are caused by the application of the algorithm for generating paths, the P₂ introduction of spheres with a radius of 1 m. Owing to the spheres, the hook performs the transition earlier than the desired path. The compensation with both approaches is most favorable with respect to the error ΔZₑ in the vertical direction. The uncompensated error increases, in the example considered, in wider ranging trolley positions and exhibits an average error of 22 cm in ΔZₑ, while the compensation keeps the error, during the entire transition, at approximately zero, and the average path error in ΔZₑ at 4.3 cm or 5.1 cm.

Overall, the proposed compensation in the vertical direction functions well and improves the path tracking performance in the horizontal direction, mainly by eliminating offsets. Thus, the advantage of the use of the corrected lifting path [symbol] for the compensation instead of [symbol] is low. The MAE is reduced, in the example considered, from 24 cm to 9 cm or 12 cm, which corresponds to an average error reduction of 50%. Both compensation approaches are particularly suitable for increasing the positioning accuracy of the rotating tower crane, in that offsets and deviations during bending are eliminated. The MAE at the target position of the proposed experiment is reduced from 44 cm to 10 cm and 5 cm.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A method for the automated positioning and/or automated moving of a load-receiving means of a crane comprising:
a calibration phase; and
a compensation and/or working operation phase;
wherein:
the calibration phase comprises:
collecting training data that characterizes positioning errors of the load-receiving means in various regions of a working region of the crane and for various lifting loads on the load-receiving means by:
moving to various intended target positions and/or travelling various intended target paths of the load-receiving means by controlling drives of the crane by means of a crane controller; and
sensing actual positions actually moved to and/or an actual travel path travelled by the load-receiving means by means of a position-sensing device in absolute coordinates; and
determining a crane model which describes the positioning errors by regression of the collected training data; and
the compensation and/or working operation phase comprises:
sensing a lifting load received and/or to be received on the load-receiving means;
correcting the intended target position and/or the intended target path of the load lift on the basis of the determined crane model according to the sensed lifting load; and
controlling the drives of the crane by means of the crane controller on the basis of the corrected intended target position and/or the corrected intended target path.

2. The method according to claim 1, wherein, when collecting the training data in the calibration phase, in each case the actual positions and/or the actual travel path are sensed in absolute coordinates, and load-receiving means positions are sensed in crane coordinates, simultaneously and in real time in each case.

3. The method according to claim 1, wherein:
the position-sensing device operating in absolute coordinates is used only in the calibration phase; and
the crane operates in the working operation phase with automated load lifts without the position-sensing device that operates in absolute coordinates.

4. The method according to claim 1, wherein, in the calibration phase, operating parameters of the drives of the crane are sensed in crane coordinates.

5. The method according to claim 1, wherein the training data comprises sensor and/or control command data of a pendulum damping system of the crane.

6. The method according to claim 1, wherein determining the crane model by regression of the training data comprises performing a linear regression with non-linear basis functions.

7. The method according to claim 1, wherein determining the crane model by regression of the training data comprises processing position data of a trolley of the crane to the second power and/or third power.

8. The method according to claim 1, wherein determining the crane model by regression of the training data comprises:
reducing a number of independent variables; and
selecting a subgroup of the independent variables for the crane model.

9. The method according to claim 1, wherein the position-sensing device is selected from a group consisting of at least one Global Navigation Satellite System (GNSS) sensor, a tachymeter system, a local ultra-wide-band tag system, and a combination thereof.

10. The method according to claim 1, wherein the calibration phase is performed on a construction site on which the working operation phase is also performed.

11. The method according to claim 1, wherein:
the calibration phase is performed on a test site, during which a reference location is determined and the crane model is related thereto;
the working operation phase with automated load lifts is performed on a construction site different from the test site; and
an erection location of the crane in the construction site for the working operation phase is selected depending on the reference location and a reference point of a georeferenced construction site coordinate system.

12. A crane comprising:
a boom pivotable about a vertical axis;
a hoist rope that runs from the boom;
a load-receiving means;
a lifting mechanism configured to lower and raise the load-receiving means via the hoist rope;
one or more drives of the crane selected from a group consisting of a slewing gear, a trolley travel drive, and the lifting mechanism; and
a crane controller for controlling the one or more drives of the crane by the method according to claim 1, the crane controller comprising:
a calibration module configured to perform the calibration phase of the method according to claim 1; and
a compensation and/or working operation module configured to perform the compensation and/or working operation phase of the method according to claim 1.

13. A method for correcting positioning errors and/or deviations of a path of a load-receiving means of a crane in georeferenced coordinates of a construction site comprising:
collecting training data that characterise positioning errors of the load-receiving means in various regions of a working region of the crane and for various lifting loads on the load-receiving means by:
moving to various intended target positions and/or travelling various intended target paths of the load-receiving means by controlling drives of the crane by means of a crane controller; and
sensing actual positions actually moved to and/or an actual travel path travelled by the load-receiving means by means of a position-sensing device in absolute coordinates; and
determining a crane model which describes the positioning errors and portions of a working operation of the crane in which no intended target positions and/or intended target paths were moved to, by regression of the collected training data.

14. A system for correcting positioning errors and/or deviations of a path of a load hook of a crane in georeferenced coordinates of a construction site comprising:
a calibration module; and
a compensation module;
wherein:
the calibration module is configured, in a calibration phase, for:
collecting training data that characterise positioning errors of the load hook in various regions of a working region of the crane and for various lifting loads on the load hook by:
moving to various intended target positions and/or travelling various intended target paths of the load-receiving means by controlling drives of the crane by means of a crane controller; and
sensing actual positions actually moved to and/or an actual travel path travelled by the load-hook by means of a position-sensing device in absolute coordinates; and
determining a crane model which describes the positioning errors by regression of the collected training data; and
the compensation module is configured, in a working operation phase, for:
sensing a lifting load received and/or to be received on the load-hook; and
correcting the intended target position and/or the intended target path of an automated load lift on the basis of the determined crane model according to the sensed lifting load.

15. The method according to claim 5, wherein the training data includes data selected from a group consisting of:
positions of the drives of the crane;
speeds of the drives of the crane;
a payload measured by a load sensor;
control commands of the crane controller;
squared and cubic trolley positions;
approximated payload fluctuation distances; and
a combination thereof.

16. The method according to claim 1, wherein determining the crane model by regression of the training data comprises applying a least absolute shrinkage and selection operator (LASSO) regression method.
